(19) United States
(12) Patent Application Publication
(10) Pub. No.: US 2026/0264595 A1
(43) Pub. Date: Sep. 10, 2026

(54) POSITIONING DEVICE FOR A SEATING DEVICE

(71) Applicant: Gentherm Incorporated, Novi, MI (US)

(72) Inventors: Andrew Charles White, West Bloomfield, MI (US); David Eisenbacher, Troy, MI (US)

(21) Appl. No.: 19/546,630

(22) Filed: Feb. 23, 2026

Related U.S. Application Data
(60) Provisional application No. 63/767,265, filed on Mar. 5, 2025.

(51) Int. Cl. B60N 2/90; B60N 2/56

(52) U.S. Cl. CPC B60N 2/914; B60N 2/5657

(57) ABSTRACT

A positioning device for moving or positioning a user or occupant in a seating device, the positioning device includes a left base air cell and a right base air cell that are separately inflatable and are fluidly isolated from each other; a left shoulder air cell including: i) an upper portion overlying at least a portion of the left base air cell, and ii) a lower portion extending downwardly away from the left base air cell; and a right shoulder air cell including: i) an upper portion overlying at least a portion of the right base air cell, and ii) a lower portion extending downwardly away from the right base air cell.

### CROSS-REFERENCE TO RELATED APPLICATIONS

This application claims priority to US 63/767,265 filed on March 05, 2025, the entirety of which is hereby incorporated by reference herein for all purposes.

### FIELD

These teachings relate to a positioning device for a seating device, such as a vehicle seat.

### BACKGROUND

Some seating devices may include one or more devices for improving user or occupant comfort and/or safety. For example, a seating deivce, such as a vehicle seat, may include a thermal device to provide heating and/or cooling functions to an occupant or user of the vehicle seat. A vehicle seat may include a positioning device to move and/or support a user or occupant in a particular position in the vehicle seat to improve occupant posture and comfort and/or to reduce occupant whiplash during aggressive braking or a collision.

Some positioning devices utilize mechanical or pneumatic adjustment elements to move and support a user or occupant in a particular position in the vehicle seat. However, mechanical elements are often complex and noisy during use, and often time only move or adjust a user or occupant’s position in a single direction. Some pneumatic elements are limited in the amount a user or occupant can be moved, and often time air can transfer between air cells if/when a user or occupant moves or shifts in the vehicle seat. Accordingly, it may be desirable to improve the current state in the art.

### SUMMARY

These teachings provide an improved positioning device for a seating device. The seating device may take the form of, or be incorporated into, a vehicle seat, including a seat for an automobile, truck, bus, train, aircraft, or other transportation device. In other embodiments, the seating device may comprise a home, office, or commercial seating device, such as a chair, recliner, couch, sofa, bench, or theater seat.

The positioning device according to these teachings comprises a single elongated structure that is configured to substantially cover an entire width of a vehicle seat back in a cross-car direction. The single elongated structure has a barrier or seam that defines or separates the elongated structure into two base air cells or bladders. The two air cells or bladders are fluidly isolated from each other by way of the barrier or seam. This means that a fluid or air exchange does not take place between the two air cells. This means that fluid or air cannot travel or be moved from one air cell to another. The barrier or seam is configured to prevent air transfer between the two base air cells if/when a user or occupant moves or shifts in the seating device. The two base air cells are configured to be individually inflated and deflated.

The positioning device according to these teachings has an air cell that is fluidly connected to a respective one of the base air cells. These may be referred to as second air cells. The second air cells are arranged at the outboard sides or regions of the seating device and have a larger or greater stroke than the base air cells. This means that the second air cells are configured to be inflated and/or pressured and expand a greater amount than the amount that the base air cells expand when inflated and/or pressurized.

Each of the second air cells are in fluid communication with a respective base air cell so that air or fluid transfer is possible between a base air cell and a respective or corresponding second air cell. When at least partially inflated, the second air cells are configured to apply pressure on the shoulder regions of a user or occupant of the seating device. The positioning device (e.g., base and second air cells) is free from applying direct pressure on the occupant’s upper spine area, which may cause pain or discomfort to the user or occupant of the seating device.

Structurally, the positioning device according to these teachings includes: a left base air cell and a right base air cell that are separately inflatable and are not fluidically coupled to each other or are fluidly isolated from each other; a left shoulder air cell comprising: i) an upper portion that overlaps or overlies the left base air cell and ii) a lower portion extending downwardly away from the left base air cell and does not overlap or overlie the left base air cell; a right shoulder air cell comprising: i) an upper portion that overlaps or overlies the right base air cell and ii) a lower portion extending downwardly away from the right base air cell and does not overlap or overlie the right base air cell. The positioning system according to these teachings is configured to be positioned at or near a top region of a seat back of the seating device and extend substantially across a width of the top region of the seat back of the seating device.

A method of making the positioning device according to these teachings is also disclosed. The method includes one or more steps of: applying a barrier or seal to a single elongated inflatable structure to separate the single elongated inflatable structure into a left base air cell and a right base air cell and so that the left and right base air cells are not in fluid communication with one another or are fluidity isolated from one another; attaching or connecting a left shoulder air cell to the left base air cell; attaching or connecting a right shoulder air cell to the right base air cell; and attaching or connecting the single elongated inflatable structure to a carrier. A method of incorporating the positioning device according to these teachings into a seating device is also disclosed. The method includes a step of attaching or connecting the carrier of the positioning device to or near the top region of the seat back frame of the seating device so that the occupant positioning device extends across the width of the top region of the seat back frame of the seating device.

A seating device such as a vehicle seat comprising a seat back frame and a positioning device according to these teachings is disclosed. The positioning device is positioned at or near the top region of the seat back frame of the seating device or vehicle seat and extends substantially across the width of the top region of the seat back frame of the seating device or vehicle seat.

As used herein, “seat frame” refers to a structural support assembly of a seat or seating device configured to support seat components and an occupant. The seat frame may include a base frame, a back frame, associated structural members, and, in some embodiments, a seat suspension supported by the structural members. The seat suspension may comprise one or more flexible support elements, such as metal wires (e.g., sinuous wires), grids, meshes, springs, elastomeric supports, or other load-distributing structures.

By way of example, a positioning device according to these teachings may be attached to or supported by the seat frame, one or more fluid supplies (e.g., fans, blowers, valves, or combinations thereof), one or more seat cushions, a ventilation device, a heating mat or heating device, or any combination of the foregoing.

A method of operating a positioning device according to these teachings is disclsoed. The method comprises one or more steps including inflating the left base air cell and the left shoulder air cell without inflating the right base air cell and the right shoulder air cell, or vice versa. The left base air cell is not fluidly connected to or is fluidly isolated from the right base air cell, and the left shoulder air cell is not fluidly connected to or is fluidity isolated from the right shoulder air cell.

Advantageously, upon activation or inflation of the positioning device according to these teachings, the positioning device is configured to apply targeted pressure onto the shoulders of the user or occupant of the seat. Accordingly, this pressure on the occupant’s shoulders may function to properly move or position the occupant in the seat for optimum comfort, posture, and safety. The positioning device does not provide direct pressure on the thoracic spine (e.g., middle back) of the user or occupant, which leads to improved comfort and reduced localized loading on the spine, while still providing effective lateral and upper-torso positioning. This arrangement may help maintain a neutral spinal posture, reduce fatigue during extended seating, and improve perceived comfort without restricting occupant movement or causing discomfort at the center of the seat back.

### BRIEF DESCRIPTION OF THE DRAWINGS

FIG. 1 is a side view of a vehicle comprising seating devices in the form of vehicle seats.

FIG. 2 is a perspective view of a seat back frame of a seating device and a positioning device according to these teachings.

FIG. 3 is a front view of a positioning device according to these teachings.

FIG. 4 is a front view of a positioning device according to these teachings in an inflated configuration.

FIG. 5 is a perspective view of a seat back frame of a seating device and a positioning device according to these teachings.

### DETAILED DESCRIPTION

The teachings herein illustrate and describe a positioning device for a seating device. In some configurations, the positioning device may also or may instead be referred to as an occupant positioning device, a user positioning device, or a combination thereof. A seating device according to these teachings may comprise any structure configured to support a user or occupant in a seated, semi-reclined, or reclined position. The seating device may include, without limitation, a seat bottom, a seat back, and optionally one or more of a headrest, armrest, footrest, or other support components. The seating device may be configured to support at least a portion of an occupant’s torso, shoulders, back, hips, or legs during use.

A seating device may take the form of, or be incorporated into, a vehicle seat, including a seat for an automobile, truck, bus, train, aircraft, or other transportation device. In other embodiments, the seating device may take the form of, or be incorporated into, a home, office, or commercial seating device, such as a chair, recliner, couch, sofa, bench, or theater seat.

A seating device may generally include a structural frame. The frame may be configured to provide structural or mechanical support to the elements of the seating device. In some configurations, such as those for a vehicle like an automobile, bus, truck, train, airplane, etc. the frame may be formed from a high-strength structural material including stamped and welded steel, aluminum alloy, magnesium alloy, or a reinforced composite material, selected to provide sufficient load-bearing capacity for occupant support. In some configurations, such as for a household or office chair or recliner, the frame may be constructed from hardwood, engineered wood, metal, or combinations thereof, selected to provide sufficient structural rigidity and durability for supporting seated occupants under repeated loading.

One or more cushioning elements may be disposed or supported on or by the frame. The cushioning elements may comprise a cushion, foam, elastomeric materials, suspension, springs, etc. One or more layers of trim, upholstery, or cover materials may be disposed over the cushioning elements.

In some configurations, one or more elements of the positioning device and/or comfort device may be attached to or supported on a suspension or support plate. A suspension or support plate may be a structural device onto which one or more elements of the positioning device and/or comfort device and/or seating device may be attached to or built on as a sub assembly.

The suspension or support plate may be a plate, a wire structure, or both. The suspension or support plate may provide a reaction surface against which the one or more air cells can be inflated against to redirect expansion of the air cell in an opposite direction. The suspension or support plate may be made of the same materials as the seat frame, such as metal, aluminum, wood, composite, or a combination thereof. The suspension or support plate sub assembly may then be attached to the structural frame via one or more attachment devices, such as wires, springs, rivets, screws, bolts, and/or other suitable fasteners. Such a suspension or support plate sub assembly may advantageously allow for certain parts of the seating device disclosed herein to be built or assembled in a separate line or facility before being ultimately attached to the frame.

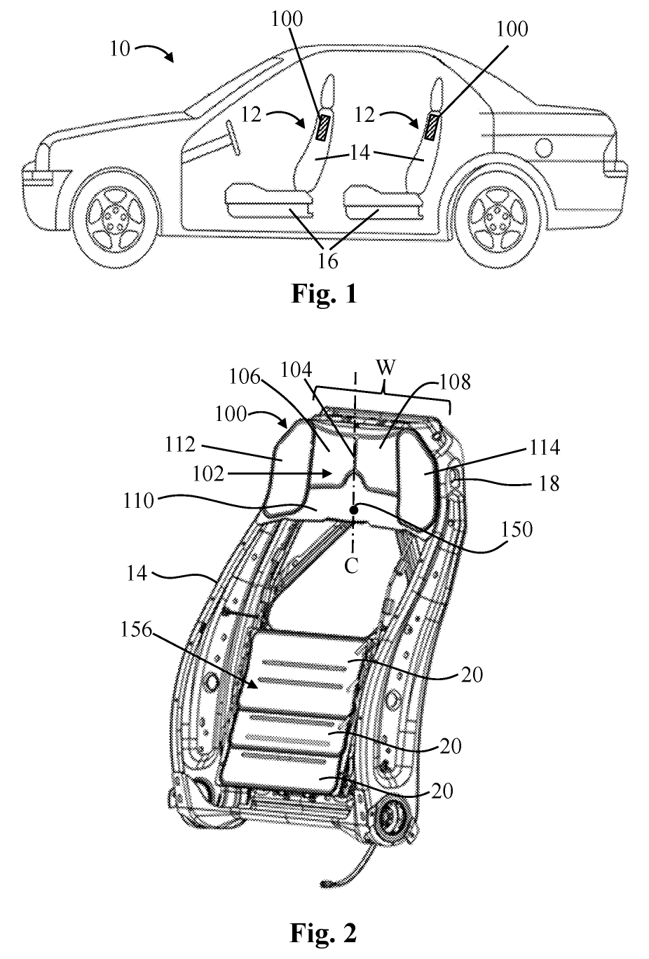

FIG. 1 illustrates a vehicle 10 comprising one or more seating devices 12. The one or more seating devices may be vehicle seats 12. As used herein, a vehicle seat 12 may be a front seat (driver or passenger seat) or a rear seat located behind the front seat(s). In other embodiments, the seating device 12 may take the form of, or be incorporated into, a home, office, or commercial seating device, such as a chair, recliner, couch, sofa, bench, or theater seat.

Generally, a seating device 12 comprises a seat frame that supports one or more cushions and the user or occupant. The seat frame may have a seat back frame 14 that supports a back of a user or occupant and a seat bottom frame 16 that supports a bottom of an occupant. One or more of the seating devices or vehicle seats 12 may comprise one or more positioning devices 100 according to the teachings herein.

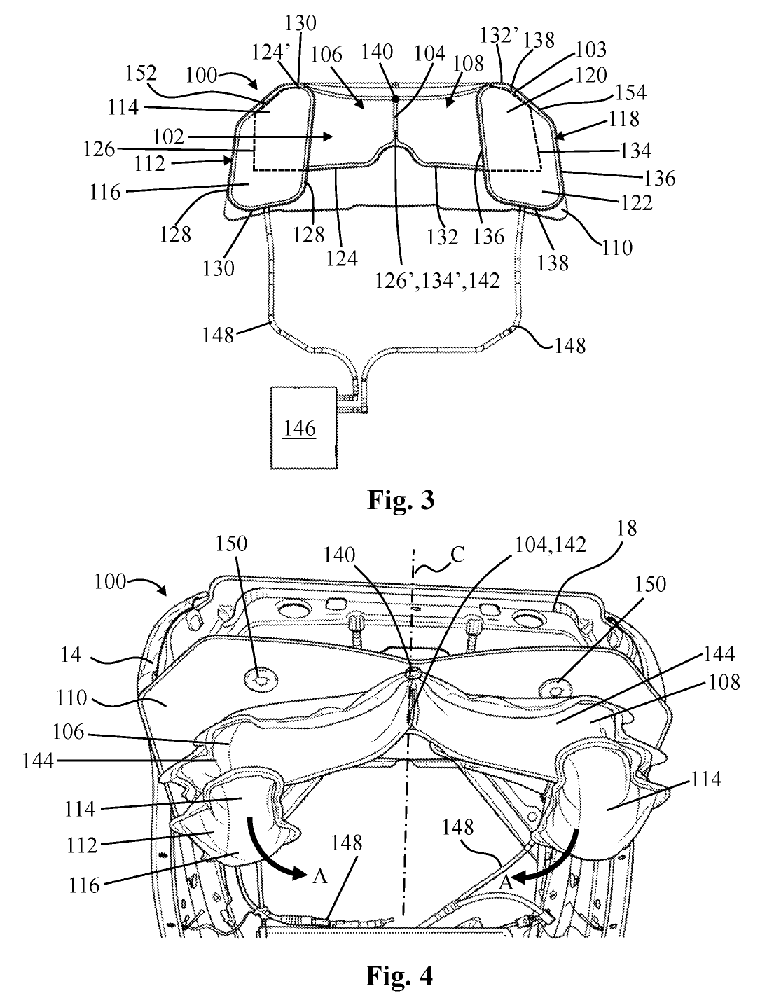

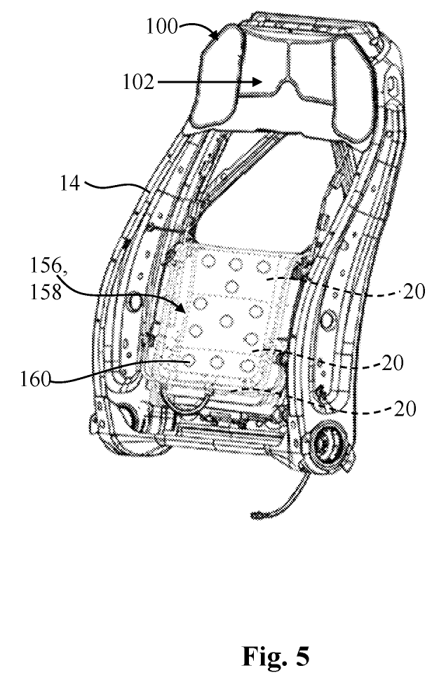

FIG. 2 illustrates a seat back frame 14 of a seat frame of a seating device and a positioning device 100 installed thereon. FIG. 3 illustrates a positioning device 100. FIG. 4 illustrates a positioning device 100 in an inflated or active configuration. FIG. 5 illustrates a seat back frame 14 of a seating device and a positioning device 100 installed thereon and further including a comfort device 156.

The positioning device 100 may generally include an inflatable foil or structure 102. The inflatable structure 102 may be a single elongated structure. The inflatable structure 102 may be made of two or more thin plastic foils, films, or sheets, for example having a thickness of 0.3 to 0.5 mm, which are connected or joined together at their edges or periphery 103 to create an inflatable chamber or member. The material of the plastic film or sheet may be a TPU (thermoplastic polyurethane). The edges or periphery 103 may be joined or sealed together via a fastener such as an adhesive, welding, radio frequency welding (RF welding), ultra sonic welding, solvent welding, vibration welding, etc.

The inflatable structure 102 may comprise one or more barriers, seams, or dividers 104 that separate or divide the inflatable structure 102 into two or more air chambers or cells, namely a left base air chamber or cell 106 and a right base air chamber or cell 108. The barrier or divider 104 may be a suitable wall, barrier, rib, or structure or may be formed at the material of the structure 102 via a weld, RF welding process, or other suitable joining process such as adhesives and the like to fluidly isolate and prevent fluid or air communication or transfer between the left and right base air cells 106, 108. In other words, the left and right base air cells 106, 108 are fluidly isolated from one another. Accordingly, during use, the left and right base chambers or air cells 106, 108 are separately inflatable and inflatable, and are not fluidly coupled or connected to one another due at least in part to the barrier 104. In other words, while the left base air cell 106 and the right base air cell 108 are integrally formed from/on a single foil structure 102, they are fluidly separated from one another by the barrier, seam, or one or more RF welds or seals 104.

The inflatable foil structure 102 may be of the type disclosed in, or may include one or more components, elements, and/or structure illustrated and/or disclosed in, U.S. Patent Publication Nos. US2012/0313420, US2018/0370405, and/or US2013/0127226, all of which is expressly incorporated by reference herein for all purposes.

In other configurations, the left and right base chambers or air cells 106, 108 may be separate structures or devices and not formed by a single elongated inflatable structure 102. Instead, the two air cells 106, 108 can be separately formed and then either directly connected by a suitable attachment or connecting process (e.g., welding, adhesives, etc.). Alternatively, the two air cells 106, 108 can be separately positioned, attached or supported on the carrier 110.

Referring specifically to FIGS. 2 and 4, the positioning device 100 is configured to be positioned at or near a top region 18 of a seat back frame 14 of a seating device or vehicle seat. The top region of the seat back frame 14 may be located generally at/near a user or occupant’s neck or shoulder region when an occupant is seated in the seat. The top region of the seat back frame 14 may be located generally at/near a region where a headrest can be attached to the seat back frame 14. The positioning device 100 may extend substantially across an entire width W of the top region 18 of the seat back frame 14 of the seating device or vehicle seat in a cross-car direction.

When the positioning device 100 is installed in the seating device or vehicle seat or seat frame, the barrier 104 is generally or substantially aligned with a central plane or center axis or longitudinal axis or lateral center C of the seating device, vehicle seat, or seat back frame 14.

The inflatable structure or foil structure 102 may be supported or attached on/to a carrier 110. The carrier 110 can be attached to the seat back frame 14 via one or more fasteners 150. In some configurations, the carrier 110 can be attached to a suspension or support plate via one or more fasteners 150, and the suspension or support plate can then be attached to the seat back frame 14 via one or more fasteners. The foil structure 102 may be directly connected to the carrier 110 via one or more fasteners 140. For example, the one or more fasteners 140 and/or 150 may be one or more pins, push pins, wires, zip ties, adhesives, tapes, hook and loop fasteners, or a combination thereof.

When the positioning device 100 is installed in or on the seating device, one or more of the fasteners 140 and/or 150 may be generally or substantially aligned with a central plane or center axis or lateral center C of the vehicle seat or seat back frame 14. When the positioning device 100 is installed in or on the seating device, one or more of the fasteners 140 and/or 150 may be generally or substantially arranged around a perimeter of the carrier and seat back frame 14.

The carrier 110 may be a flexible or rigid or semi flexible or semi rigid substrate configured to support elements of the inflatable structure 102. The carrier 110 may comprise a paper, felt, fabric, or polymeric material. The carrier 110 may comprise an outer coating. The material and/or coating on the carrier 110 may advantageously reduce chances or opportunity for the foil material of the air cells to stick to the seat frame of other components of the seat frame or cushion. In other words, the material and/or coating of the carrier may be selected to prevent a “slip-stick” phenomenon from occurring where two contacting surfaces alternate between sticking (static friction holding them together) and slipping (motion that occurs once force exceeds static friction), which may undesirably cause noise, vibration, chatter, etc.

The carrier 110 or felt material may advantageously function as an insulator to reduce noise during inflation or deflation, abrasion during inflation and deflation, or puncturing of the any of the air cells. In some configurations however, it is conceivable that the carrier 110 is omitted and the inflatable structure 102 is attached to the suspension or support plate or to the seat back frame 14, or to the seat cushion (A-side or B-side of the cushion). In some configurations, the carrier 110 may be the suspension or support plate. In some configurations, a second carrier behind the carrier 110 may be the suspension or support plate.

In some configurations, the carrier 110, or a second carrier or felt may cover or extend over the front or top of the foil or air cells. This may function as an insulator to reduce noise during inflation or deflation, abrasion during inflation and deflation, or puncturing of the air cells. The carrier or felt on top of the air cells may act as a force distributor on the air cells, to ensure a large or wide coverage or force application is transferred to the occupant, as opposed to isolated small force applications from the individual air cells.

The left base air cell 106 may have a generally rectangular shape defined by opposing upper and lower long sides 124 and substantially perpendicularly-oriented opposing short sides 126. In some configurations, the left base air cell 106 may have a different shape, such as an oval, rectangular, square, or oblong shape.

The left shoulder air cell 112 has a generally rectangular shape and is defined by opposing long sides 128 and a substantially perpendicularly-oriented opposing short sides 130. In some configurations, the left shoulder air cell 112 may have a different shape such as an oval, rectangular, square, or oblong shape.

Depending on the orientation of the positioning device, the long sides 124 of the left base air cell 106 may be horizontally oriented and the long sides 128 of the left shoulder air cell 112 are vertically oriented.

The left shoulder air cell 112 may comprise: i) an upper portion 114 that partially overlaps or overlies or is stacked on or against the left base air cell 106 (e.g., partially overlaps at least the region of the left base air cell 106 that includes the outboard short side 126, approximately at least 1/3 of the width of the base air cell 106) and ii) a lower portion 116 extending downwardly away from and below the left base air cell 106 and below the lower long side 124 of the base air cell 106. The lower portion 116 may not overlie or overlap or be stacked on or positioned on the left base air cell 106.

The left base air cell 106 has an inboard short side 126’ that is located at or near the barrier or divider 104 and that is free from overlap by the left shoulder air cell 112. The lower portion 116 of the left shoulder air cell 112 is free from overlapping the left base air cell 106. The upper portion 114 of the left shoulder air cell 112 is aligned with and/or at least partially overlaps a top side 124’ and a left/outboard side 126 of the left base air cell 106. An outboard upper corner 152 of the left base air cell 106 and/or the left shoulder air cell 112 is downwardly slanted. Accordingly, the orientation of the left base air cell 106 and left shoulder air cell 112 results in the left base air cell 106 and the left shoulder air cell 112 can form “7”, “L” or “dogleg” shape.

The left base air cell 106 and the left shoulder air cell 112 may be mirror images of the respective right base air cell 108 and the right shoulder air cell 118. In other configurations, the left base air cell 106 and the left shoulder air cell 112 are not mirror images of the respective right base air cell 108 and the right shoulder air cell 118.

The right base air cell 108 may have a generally rectangular shape defined by opposing long sides 132 and substantially perpendicularly-oriented opposing short sides 134. In some configurations, the right base air cell 108 may have a different shape such as an oval, rectangular, square, or oblong shape.

The right shoulder air cell 118 has a generally rectangular shape defined by opposing long sides 136 and substantially perpendicularly-oriented short sides 138. In some configurations, the right shoulder air cell 118 may have a different shape such as an oval, rectangular, square, or oblong shape.

Depending on the orientation of the positioning device 102, the long sides 132 of the right base air cell 108 are horizontally oriented and the long sides 136 of the right shoulder air cell 118 is vertically oriented.

The right shoulder air cell 118 comprises: i) an upper portion 120 that overlaps, or overlies, or is stacked onto or against the right base air cell 108 (e.g., at least the region of the right base air cell 108 that includes the short side 134, approximately at least 1/3 of the width of the base air cell 108) and ii) a lower portion 122 extending downwardly away from and below the right base air cell 118.

The right base air cell 108 has an inboard short side 134’ that is located at or near the barrier or divider 104 and that is free from overlap by the right shoulder air cell 118. The lower portion 122 of the right shoulder air cell 118 is free from overlapping the right base air cell 108. The upper portion 120 of the right shoulder air cell 118 is aligned with and/or overlaps a top side 132’ and right/outboard side 134 of the right base air cell 108. An outboard upper corner 154 of the right base air cell 108 and/or the right shoulder air cell 118 is downwardly slanted. Accordingly, the orientation of the right base air cell 108 and right shoulder air cell 118 results in the right base air cell 108 and the right shoulder air cell 118 forming a “7”, “L” or “dogleg” shape.

The left shoulder air cell 112 may be fluidly connected to the left base air cell 106. This means that there are one or more openings defined between the left shoulder air cell 112 and the left base air cell 106 that allow or enable fluid or air to pass to/from/between the left base air cell 106 and the left shoulder air cell 112. Similarly, the right shoulder air cell 118 may be fluidly connected to the right base air cell 108. This means that there are one or more openings defined between the right shoulder air cell 118 and the right base air cell 108 that allow or enable fluid or air to pass to/from/between the right base air cell 108 and the right shoulder air cell 118.

The fluid and/or the air may be supplied to the base air cells 106, 108 from a fluid supply or source 146 via one or more tubes or hoses 148. The fluid supply or source 146 may comprise one or more compressors, pumps, tanks, valves, or other devices for delivering air or fluid to the one or more air cells of the positioning device 100. The fluid and/or the air may be removed from or exhausted from the air cells by venting or exhausting the air cells through the one or more tubes or hoses 148 using one or more pumps, valve devices, tanks, etc. The one or more tubes or hoses 148 and/or the fluid supply or source 146 may be secured to the frame 14 and/or carrier 110 and/or suspension or support plate.

The left and right base air cells 106, 108 are not fluidly connected together due to the barrier or wall 104 separating the air cells 106, 108. This also means that the left and right shoulder air cells 112, 118 are not fluidly connected together. Advantageously, this air or fluid isolation between the left and right sides of the device 100 prevents the transfer or deflation of air or fluid from one side of the air cells 106, 112 to the other side of the air cells 108, 118 or vice versa when an occupant leans to one side of the vehicle seat.

The overlap between the upper portion 114 of the left shoulder air cell 112 and the left base air cell 106 and between the upper portion 120 of the right shoulder air cell 118 and the right base air cell 108 advantageously allows for maximum displacement of the air cell(s) in the overlap areas, which correspond to greater pressure being applied at the shoulder regions of the occupant in the vehicle seat to properly position the occupant in the vehicle seat for maximum comfort, posture.

With specific reference now to FIGS. 3 and 4, a central part or region 142 of the foil structure 102 may be directly connected to the carrier 110 and/or the seat back frame 14 via one or more fasteners 140. For example, the one or more fasteners 140 may be one or more pins, push pins, wires, zip ties, adhesives, tapes, hook and loop fasteners, welding, vibration welding, radio frequency (RF) welding, double sided adhesive, pressure sensitive adhesives, or a combination thereof. The connection of the foil or structure 102 to the carrier 110 and/or suspension or support plate via fastener(s) 140 may be generally aligned with the central axis or plane C of the positioning device 100 and/or the seat back frame 14. This means that the two or more air chambers (e.g., the left base air cell 106 and the right base air cell 108) are connected to the carrier 110. However, the left shoulder air cell 112 is free from direct connection to the carrier 110 and the right shoulder air cell 118 is free from direct connection to the carrier 110.

In some configurations, one or more of the fasteners 140 may also extend through the carrier 110 to connect the carrier 140 to suspension or support plate and/or the seat frame 14. This may be in addition or instead of the fasteners 150 that only connect the carrier 110 to the suspension or support plate and/or seat frame 14.

A seat cushion or foam may be placed over the occupant positioning device 100 and supported by the seat back frame 14 such that the positioning device 100 is located at a back or B-side of the cushion or foam. In other configurations, the seat cushion or foam may be placed onto the seat back frame 14 and then the positioning device 100 may be placed onto or located at a front or A-side of the cushion or foam.

The opposing outboard regions 144 of the foil structure 102 may be free from direct connection to the carrier 110 and to the seat back frame 14.

During use, or during inflation of the positioning device 100, air or fluid from a fluid source 146 may be supplied to the left and right base air cells 106, 108 via one or more tubes or hoses 148. The fluid or air may then flow from each of the left and right base air cells 106, 108 into the respective left and right shoulder air cells 112, 118. However, the fluid or air does not travel between the left and right base air cells 106, 108 and/or the left and right shoulder air cells 112, 118 due to the barrier or divider 104 that separates the base air cells 106, 108. In other words, during or after inflation of the positioning device 100, inflation of the left base air cell 106 inflates the left shoulder air cell 112 and inflation of the right base air cell 108 inflates the right shoulder air cell 118.

During inflation, the elongated inflatable structure 102 may expand outwardly away from the seatback frame 14 and also pivot, fold, or rotate about its central part or region 142 or fastener 140 such that the left shoulder air cell 112 and the right shoulder air cell 118 move towards each other and towards a central plane or axis C of the vehicle seat or seat back frame 14 as illustrated by the curved arrows. This movement is due at least in part to the structure and shape of the stacked shoulder air cells and the base air cells and/or the centralized attachment of the inflatable structure 102 to the carrier at the center region 142, while the ends or sides of the inflatable structure 102 in the outboard regions 144 by the user or occupant’s shoulders are not fastened to the carrier 110.

Advantageously, upon inflation of the positioning device 100, the left shoulder air cell 112 and the right shoulder air cell 118 are configured to create a hammock or U-shape to apply targeted pressure on shoulders of the occupant in the vehicle seat 12, while the right/inboard side 126’ of the left base air cell 106 and the left/inboard side 134’ of the right base air cell 108 are arranged at a central region C of the seat back frame 14 of the vehicle seat 12 and are free from providing direct pressure on the thoracic spine (e.g., middle back) of the occupant. Accordingly, this pressure on the occupant’s shoulder may function to properly position the occupant in the seat for optimum comfort, posture, and safety.

During or after inflation, the lower portion 116 of the left shoulder air cell 112 may partially overlap a supply line 148 for inflating the left base air cell 106 and the left shoulder air cell 112; and/or the lower portion 122 of the right shoulder air cell 118 may partially overlap a supply line 148 for inflating the right base air cell 108 and the right shoulder air cell 118.

Referring back to FIG. 2, the seat may include a comfort device 156 in the form of inflatable members or air cells 20 for providing lumbar, massage, and/or support to an occupant of a seat 12. The additional inflatable members or air cells 20 may be constructed in a similar manner to the occupant support device 102 and may be connected to the same or different fluid source 146.

In some configurations, such as in the embodiment of FIG. 5, a comfort device 156 in the form of an air distribution device 158 may be placed over or onto the one or more additional inflatable members 20. The air distribution device 158 may comprise a bag like structure that is configured to distribute an air flow supplied by an air mover or fluid source 146 towards an occupant of the seating device. The air distribution device 158 may comprise an air inlet through which the air is received from the fluid source 146 into the distribution device 158. The air distribution device 158 may comprise one or more apertures, holes, ports 160 through which the air or fluid is expelled towards an occupant of the seating device. A foam cushion may be provided over or on top of the air distribution device 158. The foam or cushion may have holes, channels, or ports through which the air exiting the air destitution device 158 can be supplied towards the occupant of the seating device.

In some configurations, a comfort device in the form of a heating mat or heating device may be placed over the foam or cushion to provide thermal comfort to the occupant of the seating device.

In some configurations, one or more spacer layers may be provided. The one or more spacer layers may be one or more pieces of foam, fabric, felt, etc. The one or more spacer layers may function to prevent read-through to an A-surface of the seating device (e.g., prevent read through to the seating surface that is visible). The one or more spacer layers may function as an insulator to reduce noise of the positioning device during inflation and/or deflation. A spacer layer can be provided between the frame and the carrier, between the carrier and the air cells, between the air cells and a heater mat, between the air cells and the cushion, between the air cells and a ventilation device, or any combination thereof.

Any of the elements disclsoed herein may be assembled onto a suspension or support plate, which may then be affixed to the seat frame. For example, the positioning device, one or more comfort devices, one or more spacer layers, cushions, fluid sources, controllers, hoses, tubes, etc. may be preassembled onto one or more suspension or support plates. The suspension or support plate may then be fixed or attached to the seat frame via one or more fasteners such as one or more pins, wires, screws, welds, bolts, or combination thereof. Such a pre-assembly or sub assembly may advantageously allow the positioning device nad/or one or more comfort devices to be pre-assembled, positioned, checked, before being installed on the seat frame. This pre-assembly may be done at a separate line or facility and may advantageously speed up installation and assembly time in the overall seat.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of "a" or "one" to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers, and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers, and/or sections disclosed herein are not necessarily limited to a single embodiment. Instead, any of the elements, components, regions, layers, and/or sections disclosed herein may be substituted, combined, and/or modified with any of the elements, components, regions, layers, and/or sections disclosed herein to form one or more embodiments that may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. A positioning device for moving or positioning a user or occupant in a seating device, comprising:
a left base air cell and a right base air cell that are separately inflatable and are fluidly isolated from each other;
a left shoulder air cell comprising: i) an upper portion overlying at least a portion of the left base air cell, and ii) a lower portion extending downwardly away from the left base air cell;
a right shoulder air cell comprising: i) an upper portion overlying at least a portion of the right base air cell, and ii) a lower portion extending downwardly away from the right base air cell.

2. The positioning device according to claim 1, wherein the left base air cell and the right base air cell are defined as a single elongated inflatable structure that comprises a barrier that separates the single elongated inflatable structure into the left base air cell and the right base air cell.

3. The positioning device according to claim 2, wherein the barrier is a radio frequency (RF) weld or seam.

4. The positioning device according to claim 3, wherein the positioning device is configured to be positioned at or near a top region of a seat back frame of the seating device and to extend between opposing lateral side regions of the seat back frame of the seating device, and the barrier is generally aligned with a lateral center of the seating device or the seat back frame.

5. The positioning device according to claim 1, wherein the lower portion of the left shoulder air cell is free from overlapping or overlying the left base air cell, and/or the lower portion of the right shoulder air cell is free from overlapping or overlying the right base air cell.

6. The positioning device according to claim 1, wherein a right inboard side of the left base air cell is free from being overlaid by the left shoulder air cell and/or a left inboard side of the right base air cell is free from being overlaid by the right shoulder air cell.

7. The positioning device according to claim 6, wherein the upper portion of the left shoulder air cell is aligned with and/or overlies a top and left outboard side of the left base air cell; and/or the upper portion of the right shoulder air cell is aligned with and/or overlies a top and right outboard side of the right base air cell.

8. The positioning device according to claim 7, wherein an outboard upper corner of the left base air cell is downwardly slanted and/or an outboard upper corner of the right base air cell is downwardly slanted.

9. The positioning device according to claim 1, wherein the left base air cell has a generally rectangular shape defined by a long side and a short side, and the left shoulder air cell has a generally rectangular shape defined by a long side and a short side, wherein when installed on or in the seating device, the long side of the left base air cell is horizontally oriented and the long side of the left shoulder air cell is vertically oriented; and/or the right base air cell has a generally rectangular shape defined by a long side and a short side, and the right shoulder air cell has a generally rectangular shape defined by a long side and a short side, wherein when installed on or in the seating device, the long side of the right base air cell is horizontally oriented and the long side of the right shoulder air cell is vertically oriented.

10. The positioning device according to claim 1, wherein the left base air cell is fluidly connected with the left shoulder air cell so that inflation of the left base air cell inflates the left shoulder air cell; and/or the right base air cell is fluidly connected with the right shoulder air cell so that inflation of the right base air cell inflates the right shoulder air cell.

11. The positioning device according to claim 10, wherein during inflation of the positioning device, the left shoulder air cell and the right shoulder air cell move towards each other and towards a central plane of the seating device.

12. The positioning device according to claim 11, wherein upon inflation of the positioning device, the left shoulder air cell and the right shoulder air cell are configured to apply pressure on shoulders of the user or occupant of the seating device, and the right/inboard side of the left base air cell and the left/inboard side of the right base air cell are arranged at a central region of the seat back of the seating device such that direct pressure is not applied on the spine of the user or occupant of the seating device.

13. The positioning device according to claim 12, wherein during inflation and/or deflation of the positioning device, the positioning device pivots or folds about a central region of the positioning device located between the left base air cell and the right base air cell.

14. The positioning device according to claim 13, wherein the lower portion of the left shoulder air cell partially overlies a supply line for inflating the left base air cell and the left shoulder air cell; and/or the lower portion of the right shoulder air cell partially overlies a supply line for inflating the right base air cell and the right shoulder air cell.

15. The positioning device according to claim 1, wherein the positioning device comprises a carrier, the left base air cell is directly connected to the carrier and the left shoulder air cell is free from direct connection to the carrier; and/or the right base air cell is directly connected to the carrier and the right shoulder air cell is free from direct connection to the carrier.

16. The positioning device according to claim 15, wherein a central part of the single elongated inflatable structure is directly connected to the carrier and opposing outboard regions of the foil structure are free from direct connection to the carrier.

17. The positioning device according to claim 1, wherein the seat back of the seating device comprises foam, and the positioning device is located at a back or B-side of the foam, or the positioning device is located at a front or A-side of the foam.

18. A vehicle seat comprising the seat back frame and the positioning device according to claim 1, wherein the positioning device is positioned at or near the top region of the seat back frame of the vehicle seat and extends substantially across the width of the top region of the seat back frame of the vehicle seat.

19. A method of making the positioning device according to claim 1, wherein the method comprises:
applying a barrier or seal to a single elongated inflatable structure to separate the single elongated inflatable structure into the left base air cell and the right base air cell;
attaching or connecting the left shoulder air cell to the left base air cell;
attaching or connecting the right shoulder air cell to the right base air cell;
attaching or connecting the single elongated inflatable structure to a carrier.

20. A method of operating the positioning device according to claim 1, wherein the method comprises inflating the left base air cell and the left shoulder air cell without inflating the right base air cell and the right shoulder air cell, or vice versa.
